(19) United States
(12) Patent Application Publication
(10) Pub. No.: US 2003/0135664 A1
(43) Pub. Date: Jul. 17, 2003

(54) Device initialization method in a control system, a control system, a program for running the device initialization method on a computer, and a recording medium storing this program

(76) Inventors: Hiroaki Hayashi, Ueda-shi (JP); Atsushi Sakai, Ueda-shi (JP); Toshiyuki Sugimoto, Matsumoto-shi (JP)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 10/325,067

(22) Filed: Dec. 20, 2002

(30) Foreign Application Priority Data
Dec. 27, 2001 (JP) 2001-398530

(51) Int. Cl. G06F 13/10

(52) U.S. Cl. 709/321

(57) ABSTRACT

A control system having multiple connected devices runs a common initialization process in response to initialization requests for multiple devices. When a power supply switch 26 turns on and power is supplied simultaneously to each of multiple devices (S100), an ID number is assigned to the power on signal and sent to each device service object (DS) 34 (S106). Each service object DS 34 then outputs an initialization request to the initialization object 42 (S108). The initialization object 42 runs a common initialization process for the multiple initialization requests (S110, S112), and when initialization is completed sends an initialization completion report to each service object DS 34 (S114).

### BACKGROUND OF THE INVENTION

1. Field of the Invention

The present invention relates: to a method for initializing individual devices in a control system that controls multiple devices; to a program for executing this method on a computer; and to a data storage medium for recording this program.

The invention also relates to a control system suitable for controlling the multiple devices after the devices are appropriately initialized.

2. Description of the Related Art

Programs written in the object-oriented programming language Java® run on a Java Virtual Machine (JVM). Java applications can therefore be used on any operating system (OS) that supports the JVM, regardless of the type or version of the OS. A software application to be used on multiple operating systems therefore does not need to be separately developed for each different OS, and application development is thus more cost-effective. Furthermore, because a common software application can also be provided for different operating systems, users have access to a wider selection of software and can continue to use existing software resources even after upgrading the OS.

POS systems such as used at the cash register in retail stores are configured by connecting a printer, cash drawer, and other peripheral devices to a host computer such as a personal computer. The functions of a POS system are achieved running on the host computer an application program to control the peripheral devices. If the application program run by the host computer in this type of POS system was written in Java, new POS systems can be easily configured using existing hardware. Software development costs can also be reduced so that the financial burden (cost) to the user is less.

FIG. 1 is a system diagram of a POS system 100′ built with a Java application (referred to below as a JavaPOS system). As shown in FIG. 1 this JavaPOS system 100′ has devices such as a printer 14′, cash drawer 16′, and MICR device 18′ connected to a host computer 12′. The JavaPOS system 100′ has a function for processing checks, and the MICR device 18′ executes a magnetic ink character recognition (MICR) process to read information printed using magnetic ink characters on the front of the check.

The OS of the host computer 12′ supports the JVM 30′. The JVM 30′ has a device control object (DC) 32′ for each device category (for each type of device such as printer, cash drawer, and MICR device), and a device service object (DS) 34′ for each device model. The control objects 32′ are provided as part of the system for each device category, and the service objects 34′ are supplied by the device manufacturer for each device model. To differentiate the control objects 32′ and service objects 34′ provided for the printer 14′, cash drawer 16′, and MICR device 18′, the specific device control objects are referenced below as a printer DC 32a′, a cash drawer DC 32b′, and a MICR DC 32c′, and specific device service objects are referenced below as a printer DS 34a′, a cash drawer DS 34b′, and a MICR DS 34c′.

An application program (POS application program) 36′ for achieving POS system functionality by controlling device input and output runs on the JVM 30′. In order to use the printer 14′, for example, the POS application 36′ first declares using the printer 14′ and then creates an instance of the printer device class to obtain the DS 34a′ for printer 14′. When the POS application 36′ then issues a print command, the print data is passed to the printer DC 32a′, and the printer DC 32a′ invokes the printer DS 34a′. The printer DS 34a′ then sends the print data through a port driver 35′ to the printer 14′, and the printing process runs. The print routines can therefore be written when writing the POS application 36′ without being aware of the model of printer 14′. The DS 34′ thus absorbs differences between device models, and functions as a building block for making a device-independent POS application 36′.

The general procedure in a JavaPOS system 100′ as described above when the power for an individual device turns on, is that the individual device is initialized by the device service object DS 34′ provided for that device model. In other words, each DS 34′ includes an initialization routine whereby this initialization process is run, and when a particular device turns on the initialization routine of the corresponding DS 34′ runs. In the initialization process the host computer 12′ queries each device for the device model and functions, for example, and sets each device to a particular state.

In general, however, a POS system has a specific main device (often the printer) with the other devices connected to the main device. FIG. 2 is a system diagram showing the configuration of such a JavaPOS system 110′. All elements similar to those of FIG. 1 have similar reference characters and or not described below. In the present case, power is supplied from a main device to the other devices in this control system configuration. If printer 14′ is the main device of the JavaPOS system 110′ as shown in FIG. 2, for example, then when printer 14 is turned on by means of switch 26, power is supplied via power lines 24 from the printer 14′ to the cash drawer 16 and to the MICR device 18′. That is, when the printer 14′ power turns on, the power supply also turns on simultaneously for each other device connected to the printer 14′. In other words, power turns on simultaneously for multiple devices. The initialization processes for each of the devices are therefore executed simultaneously in parallel by the DS 34′ for each device when device power turns on.

However, the initialization process run by each DS 34′ runs without synchronizing with any other DS 34′ (that is, without consideration for whatever processes another DS 34′ may be running). As a result, if while one DS 34′ is running an initialization process the host computer 12′ returns a reply to the initialization process run by another DS 34′, each DS 34′ running an initialization process is unable to determine if the host is responding to its own initialization process or to the initialization process of another DS 34′, and the initialization processes may not run correctly.

For example, if the MICR DS 34c for the MICR device 18 requests the ROM version of the MICR device 18 during the initialization process and at substantially the same time the printer DS 34a requests the functions of the printer 14, responses by the host computer 12 to these requests are returned to both MICR DS 34c and printer DS 34a. The MICR DS 34c and printer DS 34a are thus unable to determine whether the returned reply contains the ROM version of the MICR device 18 or the model of printer 14.

### OBJECTS OF THE INVENTION

The present invention is directed to solving this problem, and an object of the invention is to enable initialization processes to run appropriately in response to initialization requests for multiple devices.

### SUMMARY OF THE INVENTION

To achieve this object a method according to the present invention for running a device initialization process in a control system for controlling multiple devices has an initialization request receiving step for receiving an initialization request for each device; an initialization step for running a common initialization process for initialization requests received from multiple devices; and a completion report transmission step for sending an initialization process completion report after the common initialization process ends.

The method of this invention thus runs a common initialization process for initialization requests received for multiple devices. Operating problems arising from incorrect initialization due to unsynchronized initialization of multiple devices when an initialization process is run for each initialization request can thus be prevented. The present invention can thus properly initialize multiple devices even when simultaneous initialization requests are received from the devices.

It should be noted that an initialization process as used herein means any process that must be run first to enable normal device control, including, for example, getting the model, function, or status of the device, or setting specific device states.

The control system is preferably constructed from a computer system able to run programs written in an object-oriented programming language. The initialization request receiving step thus receives a device initialization request from objects corresponding to each of the multiple devices, and the completion report transmission step sends the completion report to each object that sent an initialization request.

Further preferably, the initialization request is output from an object responding to power turning on for each device. The initialization requests received in the initialization request receiving step contain an initialization request ID that takes the same value for each device that turned on simultaneously, and the initialization step runs a common initialization process for all initialization requests having the same initialization request ID.

The same initialization request ID is thus assigned to initialization requests issued by devices that turn on at the same time, and a common initialization process is run for each of these initialization requests. An appropriate initialization process can therefore be run for each of multiple devices sharing a common power supply and turning on at the same time.

Yet further preferably, a specific initialization request ID is assigned to an initialization request issued from an object at times other than when power turns on for the corresponding device. This specific initialization request ID is different from the initialization request ID assigned to initialization requests issued when device power turns on, and the initialization step runs a separate initialization process for initialization requests having the specific initialization request ID assigned thereto.

Initialization requests in response to device power turning on the first time can thus be differentiated from initialization requests issued when device power turns on again after the device has been initialized once. Initialization requests issued when device power cycles off and on after the device has already been initialized can therefore be processed separately.

Yet further preferably, at least one of the multiple devices is a printer, and the initialization step runs a character attribute setting process for setting print character attributes in the printer as part of the initialization process.

Yet further preferably, the method also has a step for generating character attribute data storing the print character attribute settings of the printer, and the character attribute setting process sets the print character attributes of the printer based on settings stored in the character attribute data.

This enables the print character attribute settings to be stored in the character attribute object even when the printer power is turned off, and the character attribute setting process can set the print character attributes of the printer based on the settings stored in the character attribute object. The character attributes of the printer can thus be restored to the settings used before printer power turned off.

Yet further preferably, the character attribute data is generated when the object corresponding to the printer activates.

Yet further preferably, data transmission from each object to the corresponding device is prohibited after an object issues an initialization request until the initialization completion report is received.

Yet further preferably, the specific object-oriented programming language is Java.

The above object of the invention is further achieved by a control system for controlling multiple devices, the control system having an initialization request receiving means for receiving an initialization request for each device; an initialization means for running a common initialization process for initialization requests received from multiple devices; and a completion report transmission means for sending an initialization process completion report after the common initialization process ends.

Preferably the control system is constructed from a computer system able to run programs written in a specific object-oriented programming language, the initialization request receiving means receives a device initialization request from first objects corresponding to each of the multiple devices, and the completion report transmission means sends the completion report to each first object that sent an initialization request.

Yet further preferably, the control system also has a second object for initialization processing, the second object having an initialization request receiving means, initialization means, and completion report transmission means.

Yet further preferably, the multiple devices are configured so that when the power turns on for one device the power also turns on for the other devices. The control system also has a third object for advising the first object that power turned on for each device when a signal is received in response to power turning on for the one device, and the first object sends an initialization request to the second object when the device power on report is received from the third object.

The above object is also achieved by a program for executing on a computer that is capable of executing a program written in a specific object-oriented programming language an initialization process for initializing multiple devices connected to the computer. A further aspect of the invention is a recording medium for recording this program.

Other objects and attainments together with a fuller understanding of the invention will become apparent and appreciated by referring to the following description and claims taken in conjunction with the accompanying drawings.

### BRIEF DESCRIPTION OF THE DRAWINGS

In the drawings wherein like reference symbols refer to like parts.

FIG. 1 is a system diagram of a POS system (JavaPOS system) configured from a Java application.

FIG. 2 is a system diagram of a conventional JavaPOS system.

FIG. 3 is a system diagram of a JavaPOS system according to a preferred embodiment of the invention.

FIG. 4 is a system block diagram of a printer.

FIG. 5 shows an exemplary status data configuration.

FIG. 6 shows the configuration of command parameters in an ASB function setup command.

FIG. 7 is a schematic diagram of processes run when the power turns on for each device in a JavaPOS system according to a preferred embodiment of the invention.

FIG. 8 is a flow chart of an initialization process run by the initialization class of the invention.

### DESCRIPTION OF THE PREFERRED EMBODIMENTS

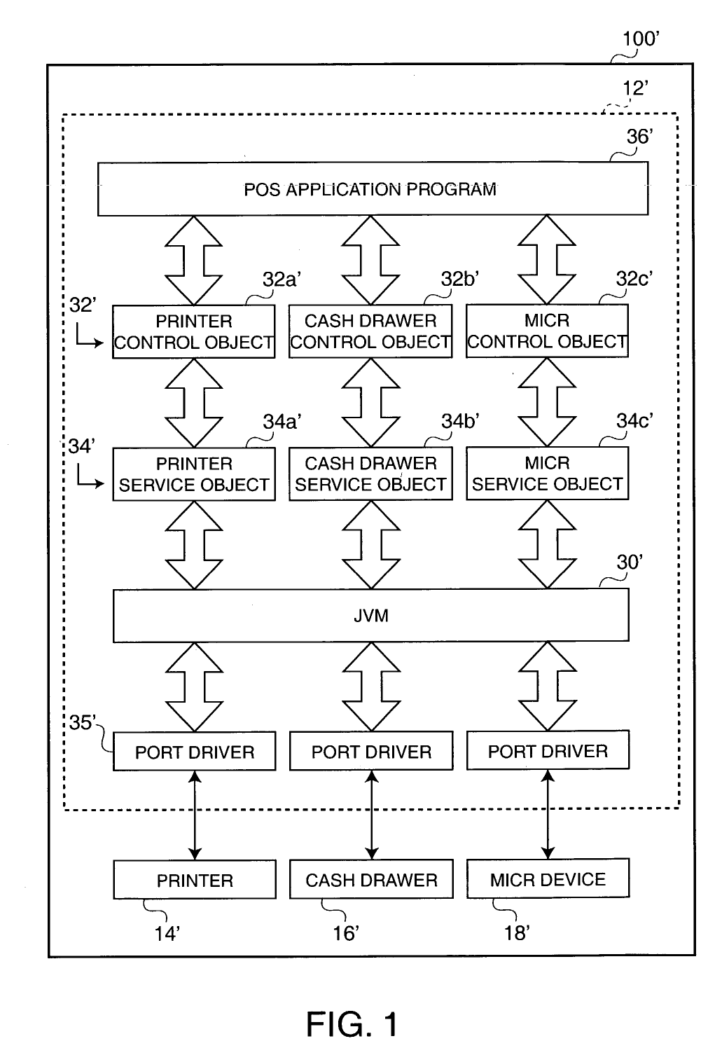

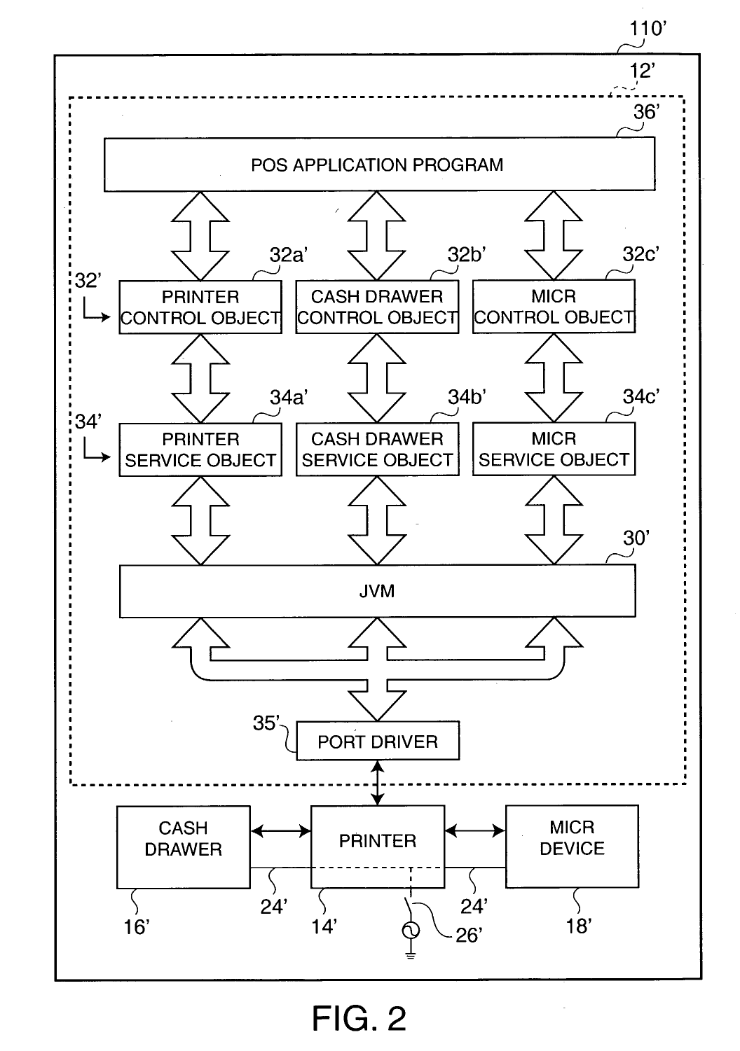

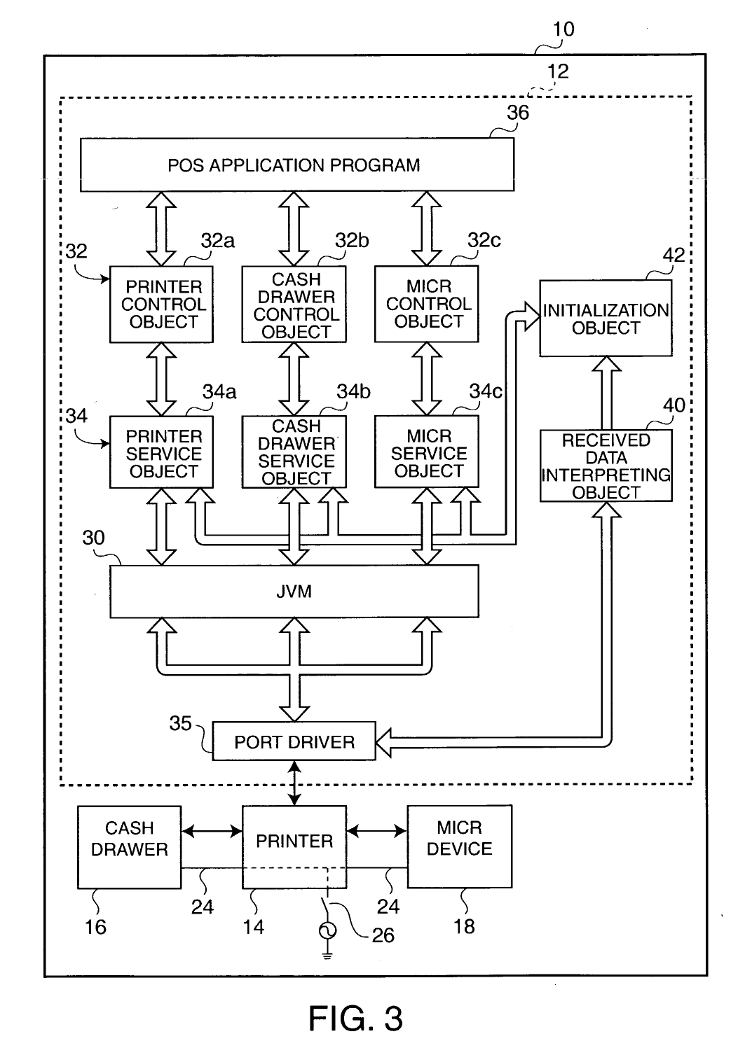

FIG. 3 is a system configuration diagram of a JavaPOS system 10 according to a preferred embodiment of the invention. Elements of FIG. 3 having a similar functionality as those of FIGS. 1 and 2 have similar reference characters with the omission of any apostrophe. As shown in FIG. 3 this JavaPOS system 10 includes a host computer 12, printer 14, cash drawer 16, and MICR device 18. The printer 14 is connected directly to the host computer 12. The cash drawer 16 and MICR device 18 are connected through the printer 14 to the host computer 12. As also shown in the figure the power supply line 24 to the cash drawer 16 and MICR device 18 is supplied from the printer 14, and when the power supply switch 26 of the printer 14 turns on, power is supplied simultaneously to each of the other devices 16 and 18.

The operating system, OS, of the host computer 12 in JavaPOS system 10 supports the JVM 30, and a device service class is provided for each device category and device control objects DC 32 are provided for each device model in the JVM 30. A POS application 36 for controlling device input and output and thereby achieving the functionality of a POS system also runs under the JVM 30. Also provided in the JavaPOS system 10 according to this embodiment of the invention are a received data interpreting object 40 and an initialization class. Note that the received data interpreting class is represented in the figures by a received data interpreting object 40 as an instance of the class. Similarly, the initialization class is represented by an initialization object 42 as an instance of the class.

The received data interpreting object 40 functions to interpret response signals from the printer 14 and pass the signals to the appropriate object.

The initialization object 42 gathers initialization requests from each DS 34 and runs the initialization processes.

DC 32, DS 34, POS application 36, received data interpreting object 40, and initialization object 42 in this preferred embodiment of the invention (or the associated classes, respectively) are programs written in the Java programming language and stored in ROM, hard disk, or other storage device accessible by the host computer 12.

As further described below commands are sent from the initialization object 42 to the printer 14, and responses from the printer 14 are sent to the initialization object 42 in the initialization process. Before further describing the initialization process, the configuration of a printer 14 used with this initialization process is described next below.

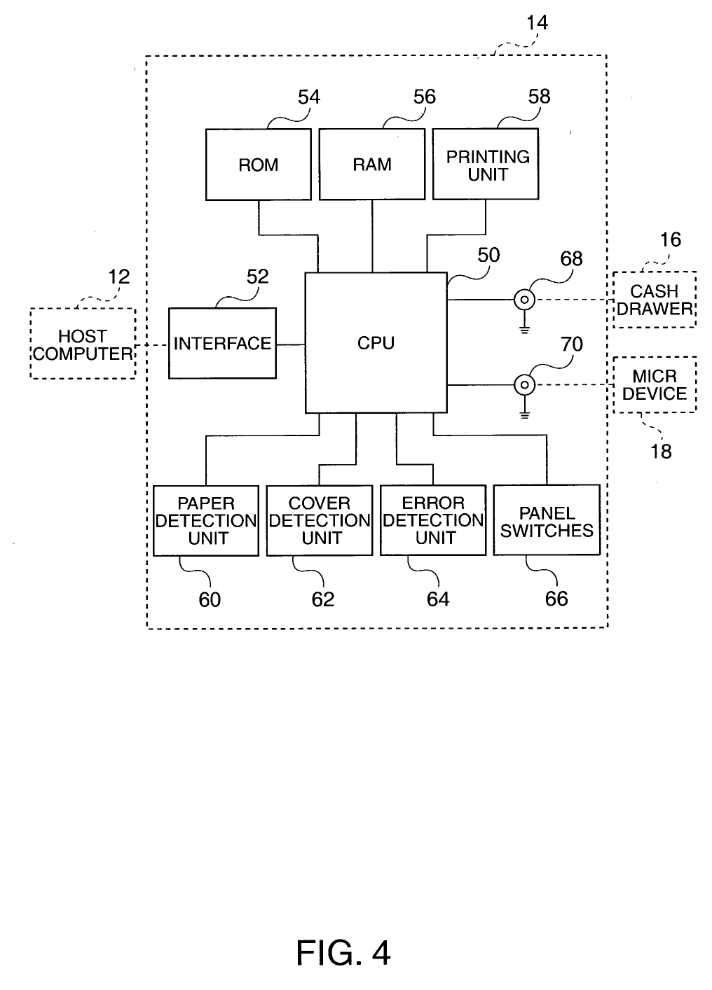

FIG. 4 is a block diagram of printer 14. As shown in FIG. 4 the printer 14 has a CPU 50. The CPU 50 is connected to host computer 12 through interface 52. Connected to the CPU 50 are ROM 54, RAM 56, printing unit 58, paper detection unit 60, cover detection unit 62, error detection unit 64, panel switches 66, and connectors 68 and 70.

A control program and print character patterns for the printer 14, and a control program and data for the MICR device 18, are stored to ROM 54. ROM 54 is therefore used by both printer 14 and MICR device 18. A receive buffer for storing commands and print data received from the host computer 12 is provided in RAM 56.

The printing unit 58 has a print head, motors for driving the print head, and related control devices, and operates to print according to commands from the CPU 50.

The paper detection unit 60 has sensors for detecting the position of slip forms and roll paper inside the printer, and reports the detection results to the CPU 50.

The cover detection unit 62 has a sensor for detecting whether the printer cover is open or closed, and reports the open/closed cover state to the CPU 50.

The error detection unit 64 has sensors for detecting whether or not the print head is at its home position for detecting the position of an automatic paper cutter, for detecting errors such as paper jams, etc. The detection results of these sensors are reported to the CPU 50.

The cash drawer 16 and MICR device 18 are connected to connectors 68 and 70, respectively, and CPU 50 detects whether the cash drawer 16 is open or closed based on the voltage level at a predetermined terminal of the connector 68.

If the CPU 50 determines that the printer cover is open, that there is no paper (slip form or roll paper) in the printer, or that an error was detected, it takes the printer 14 off-line.

The printer 14 also has an automatic status reporting function, referred to herein as an Auto Status Back (ASB) function. The ASB function automatically reports the current printer status to the host computer 12 whenever a change occurs in the status of the printer 14. Printer states reported by the ASB function in this embodiment of the invention are (1) the open/closed status of the cash drawer 16, (2) printer on-line/off-line status, (3) error status, (4) roll paper detector state, (5) slip form detector state and slip form status, and (6) the state of operating panel switches.

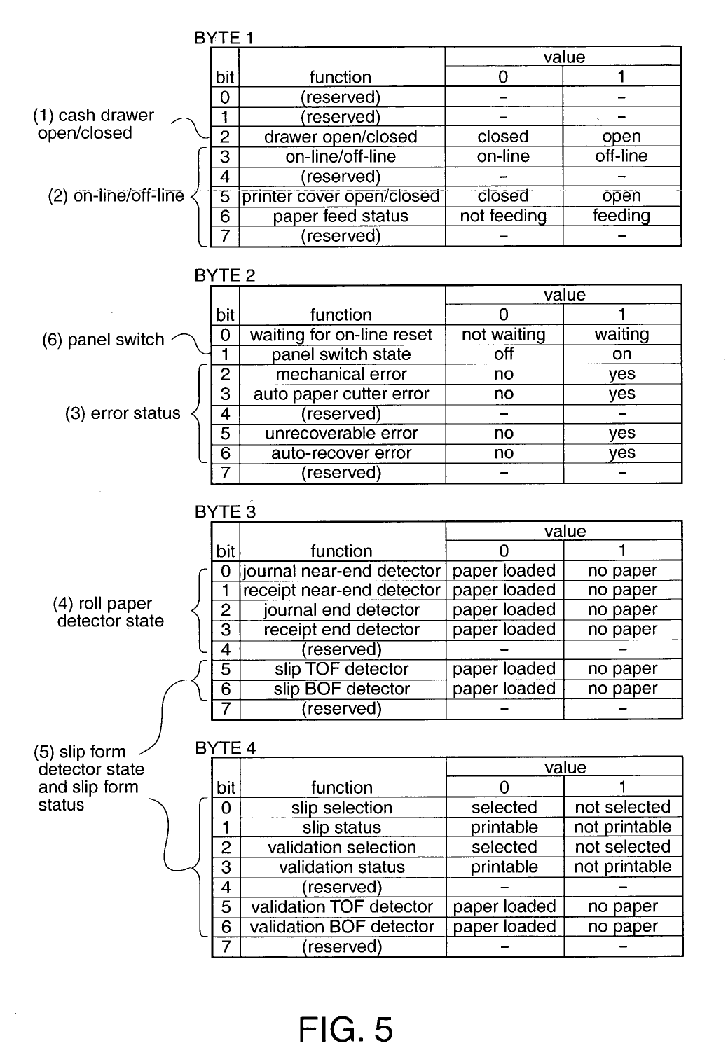

FIG. 5 shows an exemplary status data configuration. In this example the status data is 4-bytes long, and each of the above states (1) to (6) is represented by the setting of one or more bits. The CPU 50 detects each status based on the output from paper detection unit 60, cover detection unit 62, error detection unit 64, and panel switches 66, and the voltage level at a predetermined terminal of the connector 68, and sets the corresponding status bit to 1 or 0 accordingly.

When the printer 14 power turns on, the ASB function is disabled. The ASB function is enabled by the host computer 12 sending an ASB function setup command to the printer 14. The ASB function setup command contains one byte (8 bits) of command data. The ASB function can be set to an enabled or disabled state for each of the above states based on the values of these command parameters.

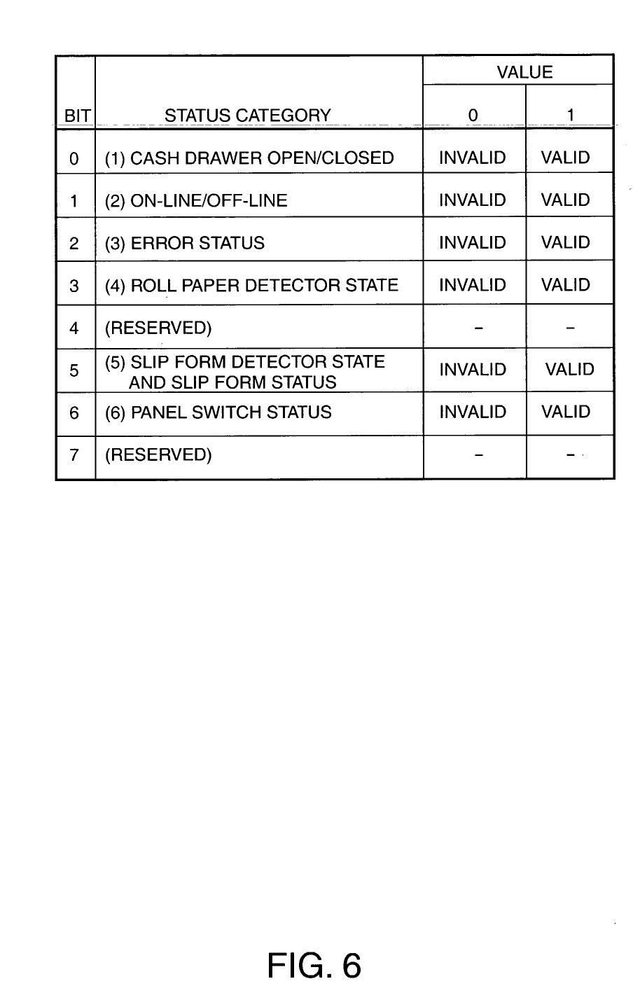

FIG. 6 shows the configuration of the command parameters. As shown in the figure, each status category corresponds to one command parameter bit, and the ASB function is enabled for each status category for which the parameter bit is 1.

When the CPU 50 receives an ASB function setup command from the host computer 12, it reports the status data content to the host computer 12 if the ASB function is enabled for any one status category by the corresponding command parameter. Thereafter, any time a status contained in a status category for which the ASB function is enabled changes, the CPU 50 sends the status data to the host computer 12.

As described above, the POS application 36 running on the host computer 12 declares using the printer 14 whenever it starts to use, the printer 14, and then creates an instance of the printer DS class (DS 34a) according to this declaration. When the POS application 36 then issues a print command, print data is passed to the printer DC 32a, and a printing process runs as a result of this printer DC 32a calling the printer, DS 34a.

When the printer DS 34a is created the instance generates character attribute command data. Each time the POS application 36 sets print character attributes (such as the font, type size, color, and styles) for the printer 14, the character attribute command data are changed in accordance with these print character attributes. The character attribute command data thus always represent information relating to the current character attribute settings of the printer 14. As further described below, the character attribute command data is passed to the initialization object 42 when initialization is requested when the printer DS 34a is created, and is used during the initialization process to restore the character attributes of the printer 14 to the settings used before printer power turned off.

The initialization process run by the initialization object 42 is described next.

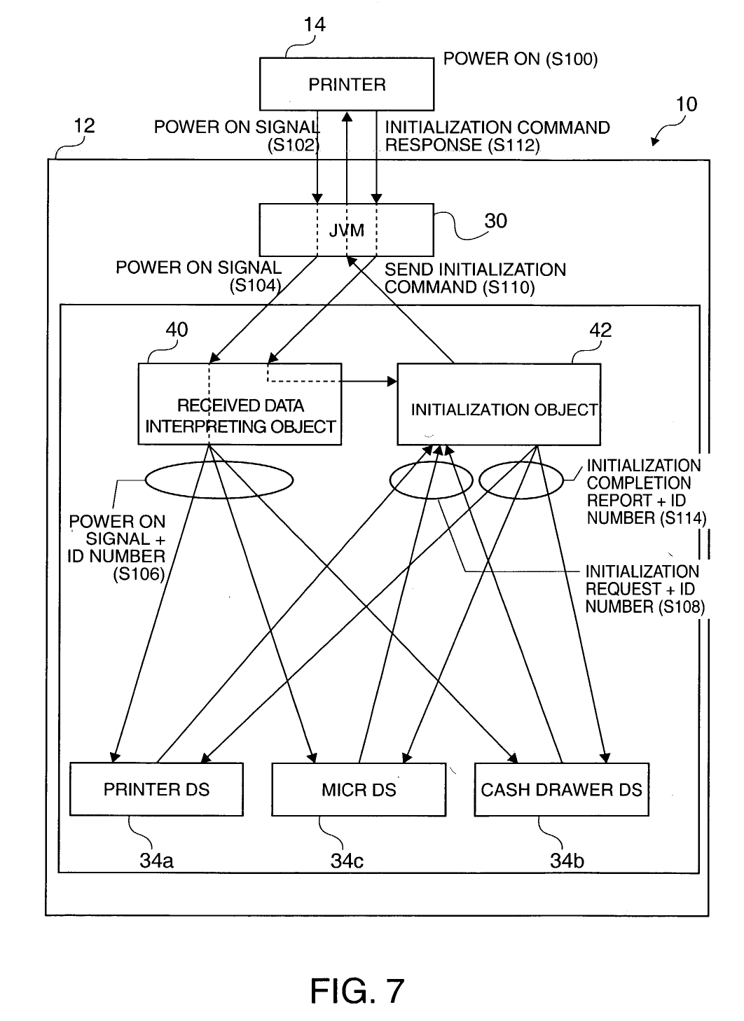

FIG. 7 outlines the process run when the power supply switch 26 turns on (that is, when power is supplied simultaneously to the printer 14, cash drawer 16, and MICR device 18) in a JavaPOS system 10 according to this embodiment of the invention. As shown in the figure, when printer 14′s power supply switch 26 turns on (S100) a power on signal is sent to the JVM 30 on host computer 12 (S102), and is passed from the JVM 30 to an object of the received data interpreting object 40 (S104). The received data interpreting object 40 generates a new ID number (a value of 1 or more) not already generated and in use according to specific rules, such as sequentially from 1 or randomly, adds this ID number to the power on signal, and passes it to each DS 34 for which an instance is already created (S106).

When each DS 34 receives the power on signal and ID number, it sends an initialization request containing the ID number to the initialization object 42 (S108). This causes the initialization object 42 to run an initialization process whereby initialization commands are sent to the printer 14 (S110) and corresponding command responses are received (S112) as described in further detail below. Responses from the printer 14 are received through the received data interpreting object 40. More specifically, the received data interpreting object 40 interprets data sent from the printer 14, determines whether the data is a response to an initialization command, and passes responses to initialization commands to the initialization object 42.

Each DS 34 issues, when it runs for the first time after having been created as an instance of the corresponding class, a first initialization request to the initialization object 42. A first initialization process is executed in response to this first initialization request. It is to be understood that this first initialization is executed when the power to the devices 14, 16, and 18 is turned on for the first time after the POS application program started. If, after the and while the POS application program is till running, the devices are switched off and then on again, another initialization process is executed each time.

When the DS 34 issue the first initialization request to the initialization object 42 they set the ID number to 0. In contrast to that, the received data interpreting object 40 sets the ID number to a value of 1 or more for each subsequent power-on initialization process. The first initialization process executed in response to the first initialization request by the printer DS 34a passes character attribute command data from the printer DS 34a to the initialization object 42.

The DS 34 also prohibits all processes transmitting data to the devices from the time when the power on signal is detected in S106 until the time when an initialization completion report is received in step S114 (described below). This prevents sending data other than initialization data during the initialization process run by the initialization object 42 to any device that has not completed initialization.

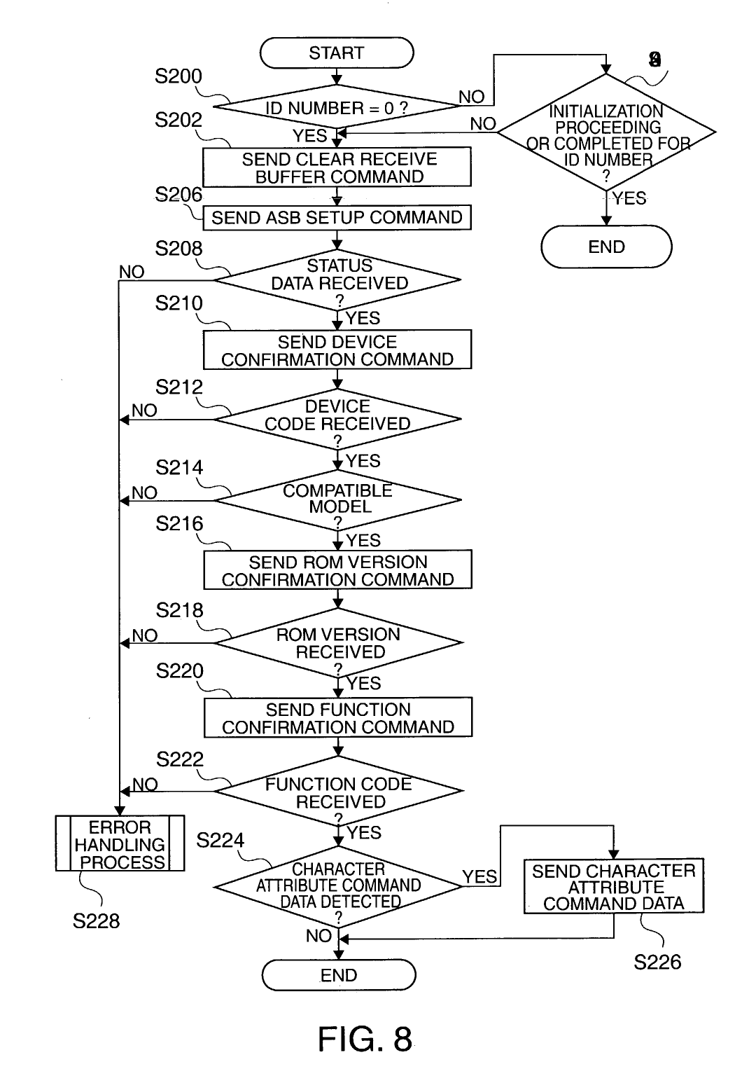

FIG. 8 is a flow chart of the initialization process run by the initialization class.

This process starts (S200) by detecting if the ID number added to the initialization request is 0. If the ID number is 0, the DS 34 instance is known to be the first initialization request issued by an instance (DS) of the device service class after the instance has been created, and the procedure moves on to, and continues from, step S202. However, if the ID number in S200 is not 0, the initialization request is known to be a power-on initialization request. Whether an initialization process has already been completed for the same ID number or whether it is still running is then determined (S204). If the initialization process has already been completed or is running, a new initialization process should not run and processing ends. Furthermore, if an initialization process has not been completed for the same ID number but an initialization process for that ID number is not running in S204, operation continues from S202.

Steps S200 and S204 thus prevent overlapping (conflicting) initialization processes for initialization requests containing the same ID number (that is, initialization requests for devices for which the power turned on simultaneously), while also enabling an initialization process to be run for each initialization request asserted when a DS 34 instance runs for the first time.

A receive buffer clear command is then sent to the printer 14 in S202. When the printer 14 CPU 50 receives a receive buffer clear command, it clears the receive buffer in RAM 56.

An ASB function setup command with the command parameter “FF” (all bits set to 1) is then sent to the printer 14 (S206). When the printer 14 CPU 50 receives this ASB function setup command it enables the ASB function for all monitored statuses, and sends the current status data to the host computer 12.

Whether status data was received from the printer 14 in response to the ASB function setup command is then determined (S208). If status data was received, step S210 runs.

A device confirmation command is then sent in S210. When the printer 14 CPU 50 receives the device confirm command it returns a device code indicating the printer 14 model to the host computer 12.

Whether a device code was received from the printer 14 is then determined (S212). If a device code was received, the printer 14 model indicated by the device code is checked for compatibility with the JavaPOS system 10 (S214). If the printer 14 is a compatible model, control steps to S216.

A ROM version confirmation command is then sent to the printer 14 (S216). When the printer 14 CPU 50 receives the ROM version confirmation command it retrieves and sends the version number from ROM 54 to host computer 12.

Whether the ROM version number was received from the printer 14 is then determined (S218). If it was received, control moves to step S220.

A function confirmation command is then sent to the printer 14 (S220). When the printer 14 CPU 50 receives the function confirmation command it returns a function code indicating the printer 14 functions (such as whether the printer has an automatic paper cutter, an endorsement printing head, and Japanese language capability) to the host computer 12.

Whether the function code was received from the printer 14 is then determined (S222). If the function code was received, whether character attribute command data is present (that is, whether a DS 34a instance for printer 14 was already created) is detected (S224). If character attribute command data is not detected, the initialization process of initialization object 42 ends. If character attribute command data is detected S224 returns yes), a set character attribute command for setting the character attributes stored in the character attribute command data is sent to the printer 14 (S226), and the initialization process of the initialization object 42 ends. By thus sending this set character attribute command in S226 the character attributes of the printer 14 can be restored to the same attributes used before printer power turned off. If the character attribute command data is not present (meaning that a printer DS 34a instance has not been created for the printer 14), the set character attribute command is not set and the initialization process is faster.

If a response from the printer 14 is not detected in step S208, S212, S218, or S222, or if the printer 14 is determined to not be a compatible model in S214, an error handling process runs in S228.

If the ID number is a value other than 0, this error handling process retries initialization by repeating the initialization process from step S200. If the ID number is 0, the error handling process returns an error to the DS 34 that issued the initialization request.

When the initialization object 42 completes the initialization process shown in FIG. 8, it sends the ID number included in the initialization request together with an initialization completion report to each DS 34 in step S114 (FIG. 7), and each DS 34 receiving the initialization completion report queries the initialization object 42 for information relating to the respective device. The initialization object 42 sends the information requested by each DS 34 from the information (status data, ROM version, printer 14 device code and function code) received from the printer 14 to the respective DS 34. The DS 34 thus gets information relating to the respective device and can thereafter appropriately control that device.

As described above, when initialization requests are received from multiple device service objects DS 34, the initialization object 42 of this embodiment of the invention gathers all initialization requests and executes a single initialization process. As a result, when multiple initialization requests are issued when the power turns on, each device can be properly initialized without an individual initialization process being run for each DS 34. In other words, whereas the initialization processes did not execute correctly due to a lack of synchronization between initialization processes when an individual initialization process was run for each DS 34 with the method of the prior art as described above, the method of the present invention runs a common initialization process for the multiple initialization processes and thereby prevents this problem of the prior art.

Furthermore, an ID number is added to the initialization request from each DS 34, and the ID number is set to the same value in the initialization requests from devices that turned on at the same time. Therefore, even if the initialization requests are sent at different times from the DS 34 of each device that turned simultaneously, a common initialization process runs only once for each of the devices, and the likelihood that the initialization process runs normally is thus increased.

Furthermore, because each time device power turns on the ID number is set to a new value not previously used, the initialization process will run normally each time the power turns on even if the power turns on and off repeatedly.

It should be noted that while a printer 14, cash drawer 16, and MICR device 18 are shown as exemplary devices connected to the host computer 12 in the above embodiment, the invention shall not be so limited and other devices such as an image scanner could be connected.

Furthermore, the invention is described using a POS system by way of example, but the invention shall not be so limited and can be widely applied for device initialization in control systems controlling multiple devices.

[Effect of the invention]

The present invention as described above can thus appropriately initialize multiple devices in response to initialization requests from the devices.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

What is claimed is:

1. A method for running a device initialization process in a control system for controlling multiple devices, comprising:
an initialization request receiving step for receiving an initialization request from each of said multiple devices;
an initialization step for running a common initialization process for each initialization request received from said multiple devices; and
a completion report transmission step for sending an initialization process completion report after the common initialization process ends.

2. A method as described in claim 1, wherein:
the control system is configured using a computer system able to run programs written in a specific object-oriented programming language; and
the initialization request receiving step receives a device initialization request from program objects corresponding to each of the multiple devices; and
the completion report transmission step sends the completion report to each program object that sent an initialization request.

3. A method as described in claim 2, wherein:
the initialization request is output from said program object in response to power turning on for each device;
the initialization requests received in the initialization request receiving step contain an initialization request ID that takes a common value for each device that turned on simultaneously; and
a separate common initialization process is associated for each initialization request ID, and the initialization step runs the same common initialization process for all initialization requests having the same initialization request ID.

4. A method as described in claim 3, wherein:
a specific initialization request ID is assigned to an initialization request issued from said program object subsequent to power turning on for each device, said specific initialization request ID being different from the initialization request ID assigned to initialization requests from said program object in response to power turning on for each device; and
the initialization step runs a separate initialization process for initialization requests having assigned thereto the specific initialization request ID.

5. A method as described in claim 1, wherein at least one of the multiple devices is a printer; and
the initialization step runs a character attribute setting process for setting print character attributes in the printer as part of at least one of a common initialization process and a separate initialization process.

6. A method as described in claim 5, further comprising:
a step for generating print character attribute data and storing the print character attribute data of the printer; wherein
the character attribute setting process sets the print character attributes of the printer based on settings stored in the print character attribute data.

7. A method as described in claim 6, wherein the character attribute data is generated when the program object corresponding to the printer activates.

8. A method as described in claim 2, wherein data transmission from each program object to the corresponding device is prohibited after any program object issues an initialization request until the initialization completion report is received.

9. A method as described in claim 1, wherein the object-oriented programming language is Java.

10. A control system for controlling multiple devices, comprising:
an initialization request receiver for receiving an initialization request from each of said multiple devices;
an initializer for running a common initialization process for each initialization request received from said multiple devices; and
a completion report transmitter for sending an initialization process completion report after the common initialization process ends.

11. A control system as described in claim 10, wherein the control system is configured using a computer system able to run programs written in a specific object-oriented programming language; and
the initialization request receiver receives a device initialization request from first program objects corresponding to each of the multiple devices; and
the completion report transmitter sends the completion report to each first program object that sent the initialization request.

12. A control system as described in claim 11, comprising a second program object for initialization processing, wherein the second program object comprising a second initialization request receiver, a second initializer, and a second completion report transmitter.

13. A control system as described in claim 12, wherein:
the multiple devices are configured so that when power turns on for one device, power also turns on for other devices;
the control system having a third program object for notifying the first program objects that power turned on for said other devices in response to a signal received in response to power turning on for said one device; and
the first program objects send an initialization request to the second program object when the device power on report is received from the third program object.

14. A program for executing an initialization process for multiple devices connected to a computer capable of executing a program written in a specific object-oriented programming language, comprising:
an initialization request receiving step for receiving an initialization request for each of said multiple devices from multiple program objects having a one-to-one correspondence with the multiple devices;
an initialization step for running a common initialization process for initialization requests received from the multiple program objects; and
a completion report transmission step for sending an initialization process completion report, after the common initialization process ends, to each of said multiple objects that issued any of said initialization requests.

15. A recording medium for recording a program as described in claim 14.
